(19) United States
(12) Patent Application Publication
(10) Pub. No.: US 2011/0217946 A1
(43) Pub. Date: Sep. 8, 2011

(54) Personal Security Device for a Personal Electronic Device

(76) Inventor: Steven J. DeAngeles, Chicago, IL (US)

(21) Appl. No.: 12/717,482

(22) Filed: Mar. 4, 2010

(51) Int. Cl. H04B 3/36; H04M 1/00; G08B 3/10

(52) U.S. Cl. 455/347; 455/575.8; 340/384.7; 340/815.4; 340/407.1; 222/192

(57) ABSTRACT

A personal security device for a cell phone or other portable electronic device is attached and removed by a clamp configured to fit the device. A non-lethal chemical, electrical, acoustic or other deterrent can be quickly directed at an attacker using the portable electronic device as a carrier for the personal security device.

### BACKGROUND

Personal electronic devices that include “cellular” telephones and portable MP3 players such as the IPOD™ have become nearly ubiquitous. Cellular telephones in particular are now so common that many children now have their own cell phones, ostensibly given to them for security reasons. Some people are believed to simply hold a cell phone to their ear while walking about, even though no call is in progress, simply to appear to be engaged in a telephone conversation.

While cell phones might give their owners and users a sense of security, the unfortunate reality is that a cellular telephone or other two-way portable communications device would be of limited or no value in the event of a sudden or unexpected violent attack. A non-lethal personal security device that might be carried with or connected to a personal electronics device would be an improvement over the prior art.

### BRIEF DESCRIPTION OF THE DRAWINGS

FIG. 1 is a perspective view of a prior art personal security device;

FIG. 2 is a cut-away view of the device depicted in FIG. 1;

FIG. 3 is a perspective view of a wireless communications device in combination with a personal security device, similar to the one shown in FIG. 1 and FIG. 2;

FIG. 4 is a top or end view of the apparatus shown in FIG. 3;

FIG. 5 is a side view of the apparatus shown in FIG. 3

FIG. 6 is front view of the apparatus shown in FIG. 3;

FIG. 7 is a rear view of the apparatus shown in FIG. 3;

FIG. 8 is an alternate embodiment of a personal security device for a personal electronic device; and

FIG. 9 is another alternate embodiment of a personal security device for a cell phone.

### DETAILED DESCRIPTION

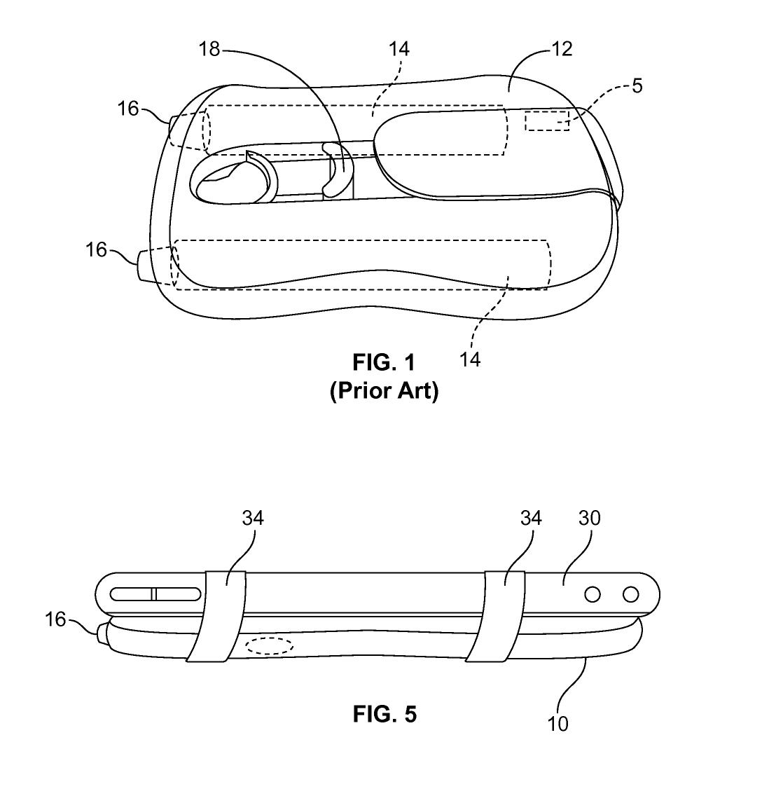

FIG. 1 is a perspective view of a prior art personal security device 10 comprised of a relatively small, injection molded housing 12 which carries two cylinders 14 of a dye or a mucous membrane irritant such as Mace® or pepper spray. One or more small explosive charges 15 sometimes referred to and/or known as a firing cap 15, exerts pressure on the contents of the cylinders 14 driving cylinders' contents through one or more nozzles 16 at a high velocity. The nozzles 16 are provided with several small diameter holes, which disperse the ejected chemical in a cone-shaped pattern in order to improve the likelihood that the cylinders' contents will strike an attacker.

The firing cap 15 is discharged when a user pulls a spring-loaded trigger mechanism 18. In the embodiment shown, the trigger mechanism 18 is actuated by withdrawing or pulling it away from the nozzles 16.

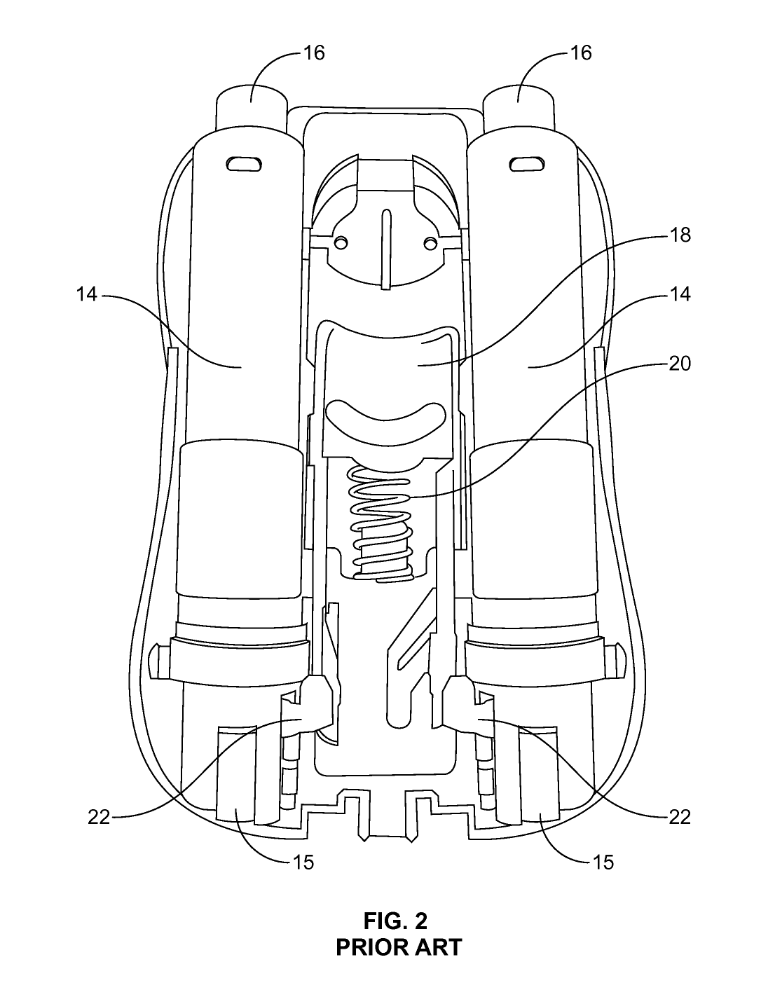

FIG. 2 shows the prior art personal security device 10 of FIG. 1 in greater detail in FIG. 2. No trigger lock is provided in order to enable the device to be used with little or no warning. The spring constant of the trigger spring 20 is selected to prevent accidental firing of the device by small children. Pulling the trigger 18 downwardly, i.e., away from the nozzles 16 drives two firing pins 22 into firing caps 15 behind the cylinders 14 causing the cylinder contents to discharge through the corresponding nozzles 16.

Personal security devices like the one depicted in FIG. 1 and FIG. 2, are available from Kimber Manufacturing, Inc., 55 Taxter Road, Suite 235, Elmsford, N.Y. The unit depicted in FIG. 1 and FIG. 2 is an example of a small, palm-sized, inexpensive, non-lethal yet highly-effective personal security device, which can also be used with on demand with little or no training. When such a device is properly configured and combined with a personal wireless communications device, the combination of the personal security device and the communications device can be quickly brought to bear against an attacker.

For the sake of completeness and clarity, as used herein, the term “cell phone” should be construed to include any form of a personal electronics device. Such devices include portable and battery-powered: MP3 players; two-way radios; two-way pagers; and all forms of wireless two-way communication devices regardless of their frequency band of operation or the modulation techniques or the service provider.

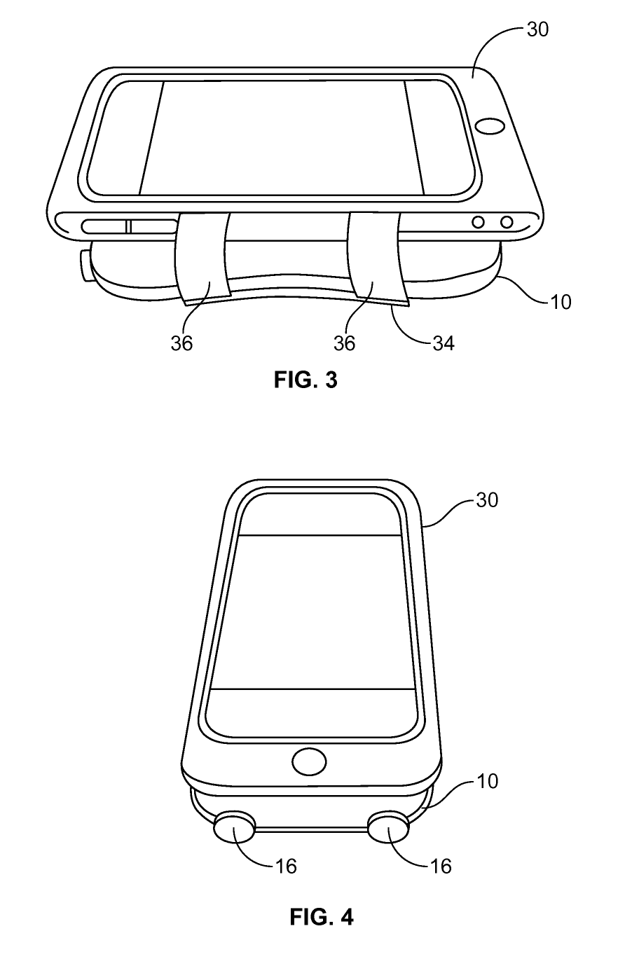

FIG. 3 is a side view of a personal security device 10, removably attached to a cell phone 30 by way of one or more flexible straps 34 that form a clamp for the back side of a corresponding cell phone 30. The clamp 34 depicted in FIG. 3 is comprised of two elastic straps 36, which are of necessity sized, shaped, and arranged to wrap around the back or bottom side of a particular cell phone model. Stated another way, the clamp 34 is, sized, shaped, and arranged to conform to the dimensions of the cell phone 30, different cell phones of different sizes and shapes requiring correspondingly configured clamps.

FIG. 4 is an end view of the device 10 depicted in FIG. 3. Two spray nozzles 16 project from one end of the device 10, preferably the “top” end of the cell phone 30.

FIG. 5 is a side view of a personal security device 10 attached to the back or rear side of a cell phone 30. It can be seen in this figure that the thickness of the personal security device 10 is substantially equal to the thickness of the cell phone 30. The personal security device form factor also fits within the “footprint” of the cell phone 30, at least with respect to the front of the cell phone 30. FIG. 4 and FIG. 5 show that the two nozzles 16 have an unobstructed “view” such that when they are directed at an object or person, the contents or other deterrent of the personal security device 10 can be discharged without impairment.

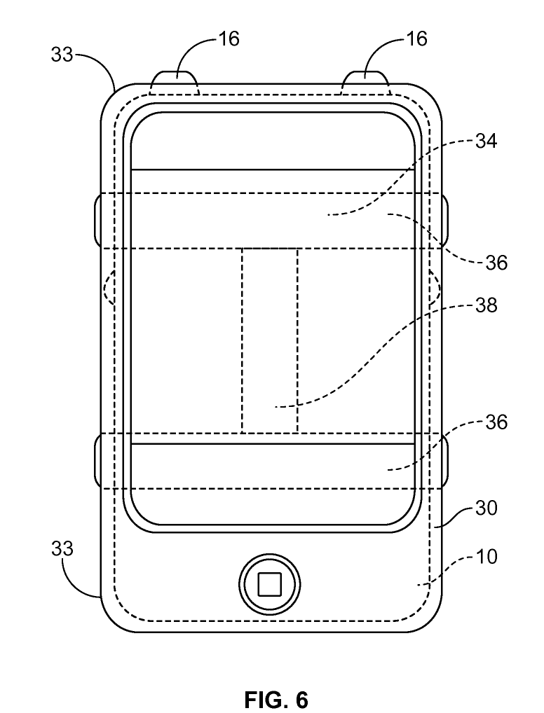

FIG. 6 is a top or front view of the cell phone 30, showing the personal security device on the back side of the cell phone 30 in broken lines. The clamp 38 that attaches the personal security device to the cell phone 30 is comprised of two straps 36 that wrap around the sides or edges 33 of the cell phone 30 and which are connected to each other by a spine 40 that extends between them. The clamp 38 is made of a flexible, injection molded plastic and can “snapped” on and off the backside of the cell phone 30 by opening the resilient material from which the clamp 34 is made.

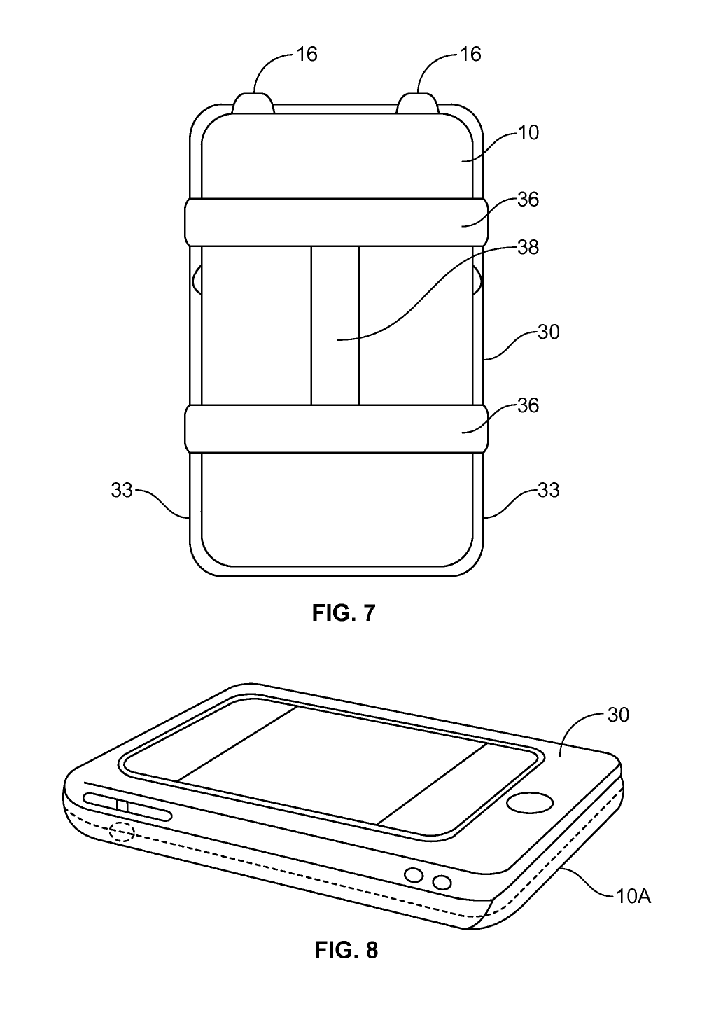

FIG. 7 shows a rear view of the personal security device 10 attached to the back side of a cell phone 30 by way of the clamp 38. The two straps 36 removably grip the sides 33 of the cell phone and hold the security device 10 against the back side of the cell phone 30.

FIG. 8 is a perspective view of an alternate embodiment of a personal security device 10A attached to a cell phone 30. In this figure, the personal security device 10A is comprised of an elastic jacket, sized, shaped and arranged to snuggly and releaseably fit over the rear half of the cell phone 30. Such conformal covers are known and used for certain types of audio file players.

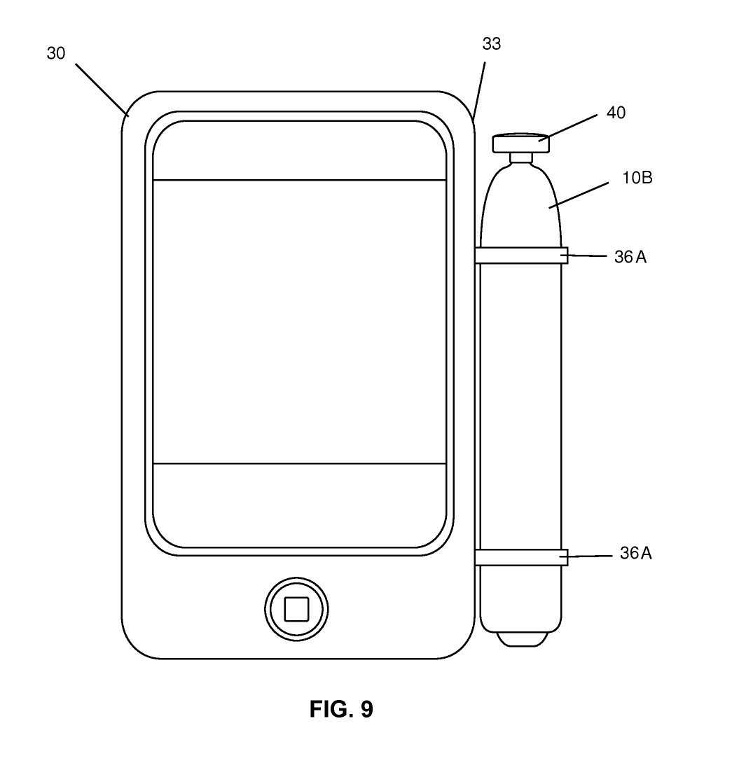

FIG. 9 is another alternate embodiment of a personal security device for a cell phone. Two small straps 36A attach a small, pressurized canister 10B of a deterrent is attached to a side edge 33 of a cell phone 30. The small straps 36A are held to the cell phone using a clamp, such as the clamp 38 described above. A chemical deterrent in the canister 10B is released by depressing the valve 40.

Those of ordinary skill in the art will appreciate that while the personal security devices 10 and 10A are configured to forcibly eject a liquid or powder chemical personnel deterrent at a high velocity, alternate embodiments of the personal security device 10 are configured to deliver a piercing audible tone through an acoustic device such as a small loudspeaker driven by a battery powered amplifier. In another embodiment, a liquid chemical deterrent is forcibly ejected from a reservoir such as the cylinders 14 using a conventional spray pump, similar to those commonly used on house-hold cleaning fluids. In another embodiment, the personal security devices 10 and 10A are provided with one or more battery-powered lasers and/or high-intensity lights such as a xenon bulb in place of the nozzles 16. When such lights are directed into the eyes of an attacker, they can at least temporarily blind an attacker. In yet another embodiment, the personal security devices 10 and 10A are configured to deliver an immobilizing electric shock. A similar device is known as a Taser® which when actuated delivers a non-lethal but nevertheless immobilizing electric charge. For purposes of claim construction, non-lethal chemical, electronic and physical agents that tend to repel, immobilize, incapacitate, irritate or disorient a person are all considered herein to be personnel deterrent agents. The conveyance or delivery of a personnel deterrent agent from the personal security device is considered to be an emission thereof, regardless of whether the personnel deterrent agent actually strikes or acts on a person.

In yet another embodiment, the personal security devices are provided with global positioning system receivers, well known to those of ordinary skill in the electronics art but which when included in the personal security devices 10 and 10A enable a user to precisely locate his position and convey the same to persons or entities that could provide additional assistance.

As set forth above, the clamp 34 is preferably formed from a plastic resilient material. In an alternate embodiment however the clamp 34 can be formed from a light weight resilient metal. The conformal elastic jacket for the alternate embodiment of the personal security device 10A is formed of a pliable plastic but in an alternate embodiment can be provided with a elastic fabric or spandex sized, shaped and arranged to grip the exterior of a cell phone device 30.

In another embodiment, the clamp 34 and the elastic jacket and the clamp 38 can be replaced instead by a hook and loop fastener. Such fasteners are commonly known or referred to as Velcro®. The back or rear side either the cell phone 30 and the opposing side of the personal security device can be provided with one-half of the hook and loop fastener to provide for ready attachment and detachment of the personal security device 10 from the cell phone 30. As used herein, the term “clamp” should be construed to include all of the embodiments described above.

Those of ordinary skill in the art will recognize that the cell phone acts as a virtual “carrier” for a personal security device. By having the personal security device attachable and detachable by a clamp, the personal security device can be added to or removed from a cell phone as needed. Since many people carry their cell phones with them at all times, having an effective, non-lethal, easy-to-use personnel deterrent agent attached to their phone provides a mechanism for more timely personal safety and defense.

The foregoing description is for purposes of illustration only. The true scope of the invention is set forth in the appurtenant claims.

What is claimed is:

1. A personal security device for a cell phone, the personal security device comprising:
a housing containing a device to emit a personnel deterrent agent;
a clamp configured to removably attach and detach the housing to and from a cell phone.

2. The personal security device of claim 1, wherein the housing is comprised of at least one nozzle, the nozzle being configured to directionally dispense a chemical deterrent agent in a pattern.

3. The personal security device of claim 2, wherein the chemical deterrent agent is a dye.

4. The personal security device of claim 2, wherein the chemical deterrent agent is a mucous membrane inflammatory agent.

5. The personal security device of claim 2, wherein the housing includes an explosive device.

6. The personal security device of claim 2, wherein the housing is comprised of a spray pump.

7. The personal security device of claim 2, wherein the housing is provided with a compressed gas.

8. The personal security device of claim 5, wherein the explosive device is a firing cap.

9. The personal security device of claim 2, wherein the clamp is formed from a resilient material, sized, shaped and arranged to grip an edge of the cell phone.

10. The personal security device of claim 2, wherein the clamp is comprised of an elastic jacket sized, shaped and arranged to conform to the cell phone and to releasably fit over a rear portion of the cell phone.

11. The personal security device of claim 2, wherein the clamp is comprised of at least one part of a hook and loop fastener.

12. The personal security device of claim 1, wherein the personal electronics device is a two-way wireless communications device.

13. The personal security device of claim 1, wherein the personal electronics device is an audio playback device.

14. A personal security device for a cell phone, the personal security device comprising:
a housing containing a battery-powered electronic deterrent device;
a clamp configured to attach and detach the housing to and from a first side of the cell phone.

15. The personal security device of claim 14, wherein the electronic deterrent device is an acoustic device, configured to enunciate at least one audible tone.

16. The personal security device of claim 14, wherein the electronic deterrent device is a high intensity light.

17. The personal security device of claim 14, wherein the electronic deterrent device is configured to deliver an electric shock.

18. The personal security device of claim 14, wherein the electronic deterrent device is comprised of a global positioning system receiver.

19. The personal security device of claim 14, wherein the clamp is formed from a resilient material, sized, shaped and arranged to grip first and second side edges of the cell phone.

20. The personal security device of claim 14, wherein the clamp is comprised of an elastic jacket sized, shaped and arranged for the cell phone.

21. The personal security device of claim 14, wherein the clamp is comprised of at least part of a hook and loop fastener, a first side of which is attached to the personal electronics device, a second side of which is attached to the housing.
